(19) United States
(12) Patent Application Publication
(10) Pub. No.: US 2017/0026731 A1
(43) Pub. Date: Jan. 26, 2017

(54) POP NOISE REDUCTION TOOL, MICROPHONE EQUIPPED THEREWITH, POP NOISE MEASUREMENT METHOD, AND POP NOISE MEASUREMENT DEVICE

(71) Applicant: TOMOEGAWA CO., LTD., Tokyo (JP)

(72) Inventors: Fukushi Kawakami, Hamamatsu-shi (JP); Noriaki Shime, Tokyo (JP); Takayuki Sano, Shizuoka-shi (JP)

(21) Appl. No.: 15/120,686

(22) PCT Filed: Feb. 27, 2015
(86) PCT No.: PCT/JP2015/055882

§ 371 Date: Aug. 22, 2016

(30) Foreign Application Priority Data
Feb. 28, 2014 (JP) 2014-037727

(51) Int. Cl. H04R 1/08; H04R 29/00

(52) U.S. Cl. CPC H04R 1/086; H04R 29/004; H04R 2410/07

(57) ABSTRACT

One of the purposes of the present invention is to provide a pop noise reduction tool capable of exhibiting an excellent pop noise reduction effect even when the tool is arranged relatively close to the diaphragm of a microphone or a microphone unit; the present invention provides a pop noise reduction tool including a sound-transmitting member which has micropores that lead from one surface to the other surface, is formed by fibers that are interlaced with each other, and has the linear light transmittance of 20% or less.

### TECHNICAL FIELD

The invention relates to a pop noise reduction tool which is capable of effectively preventing pop noise by being provided in the vicinity of a microphone unit or by being provided as a wind shield of the microphone unit, a microphone including the pop noise reduction tool, a pop noise measurement device, and a measurement method thereof.

Priority is claimed on Japanese Patent Application No. 2014-037727, filed Feb. 28, 2014, the content of which is incorporated herein by reference.

### BACKGROUND ART

If a sudden shock wind when a plosive sound such as p, t, or k is generated directly comes in contact with a microphone, wind noise referred to as so-called pop noise occurs in an output. In a case where speech is being accurately acquired using a voice recording studio or the like, such pop noise causes a significant problem. Thus, a pop noise reduction tool in which a mesh formed of elastic fibers is attached to a ring-shaped frame or a pop noise reduction tool referred to as a “pop filter” made of an expanded metal in which a metallic plate containing grooves and expanded into a net shape is provided in front of a microphone, to thereby prevent the occurrence of pop noise.

In the pop filter in which a mesh formed of elastic fibers is attached to a ring-shaped frame (which may be hereinafter referred to as an elastic fiber pop filter), a mesh portion is displaced due to a shock wind generated by a plosive sound to moderate the strength of the shock wind, and thus, it is possible to reduce the shock wind that reaches the microphone.

Further, in the pop filter of the expanded metal type (which may be hereinafter referred to as an expanded metal), the direction of a shock wind is changed using regular inclinations formed by expanding a metallic plate containing grooves into a net shape, to thereby reduce the shock wind that reaches a microphone. As a pop filter of such a type, there is also a pop filter in which a metallic or plastic material is processed into a net shape.

Furthermore, a pop noise reduction tool that achieves effects of both of an elastic fiber pop filter that uses a filter displaced by a shock wind and a filter that changes the direction of a shock wind based on devising a shape not being displaced due to the shock wind in combination, and an expanded metal has been proposed (for example, Patent Document 1).

### PRIOR ART DOCUMENT

### Patent Document

[Patent Document 1] Japanese Unexamined Patent Application, First Publication No. 2008-048309

### SUMMARY OF INVENTION

### Technical Problem

In order to enhance a pop noise reduction intensity of the above-mentioned elastic fiber pop filter in the related art, a method for increasing the density of fibers that form a mesh may be considered, but in this case, a sound transmission feature deteriorates. Further, in a case where a distance between a microphone and the elastic fiber pop filter becomes long to moderate a shock wind, a distance between a sound source and the microphone also becomes long. Accordingly, a restriction that an S/N ratio is reduced or recording using a proximity effect is not possible occurs.

Further, since the expanded metal is made of a metallic material, additional sounds (resonance sounds, scratching sounds, or the like) may occur due to a shock wind, and practically, the expanded metal is not generally used.

Furthermore, even when the two types of pop filter are used together, the above-mentioned problems consequently occur, and in reality, there is no pop noise reduction tool capable of reliably providing satisfactory pop noise reduction effects.

In this regard, there have been theoretical reviews with respect to noise generated by natural wind (steady wind), but pop noise has a particularity that the human mouth is a generation source (wind source) thereof and a particularity of being a pulse-like shock wind, and a measurement method therefor has not yet been established. There is no method for dividedly measuring a voiced part (sound part) included in a plosive sound and pop noise which is a wind noise part due to a shock wind. Further, in reality, there is no device that reproduces pop noise.

An object of the invention is to provide a pop noise reduction tool capable of achieving an excellent pop noise reduction effect even when the pop noise reduction tool is arranged relatively close to a diaphragm of a microphone or a microphone unit, a microphone equipped therewith, a pop noise measurement method, and a noise measurement device.

### Solution to Problem

In order to solve the above problems, the invention provides a pop noise reduction tool, a microphone including the pop noise reduction tool, a pop noise measurement device, and a noise measurement device as follows.

(1) A pop noise reduction tool including a sound-transmitting member which has micropores that lead from one surface thereof to the other surface thereof and is formed by fibers that are interlaced with each other, and has a linear light transmittance of 20% or less.

(2) The pop noise reduction tool according to (1), wherein the sound-transmitting member is mounted on a microphone, and further serves as a wind shield for protecting a microphone unit.

(3) The pop noise reduction tool according to (1), wherein the pop noise reduction tool includes at least two sound-transmitting members.

(4) The pop noise reduction tool according to (3), wherein at least one of the sound-transmitting members has a thin plate shape, and another one thereof serves as a wind shield for protecting a microphone unit and is mounted on a microphone.

(5) The pop noise reduction tool according to (3), wherein the sound-transmitting members are arranged so that a distance therebetween is 2 mm to 50 mm.

(6) The pop noise reduction tool according to (1), wherein a linear distance between a diaphragm of a microphone unit and at least one of the pop noise reduction tools is equal to or greater than 25 mm.

(7) The pop noise reduction tool according to (1), wherein vibration-proofing of the sound-transmitting member is secured by an elastic member.

(8) The pop noise reduction tool according to (1), wherein the pop noise reduction tool further includes a fixing member for fixing the pop noise reduction tool at a predetermined position.

(9) The pop noise reduction tool according to (1), a pop noise attenuation measured by a pop noise measurement method including a pop noise reproduction process of generating a silent shock wind and a sound acquisition process of acquiring pop noise generated by a shock wind generated in the silent shock wind generation process is equal to or greater than 25 db.

(10) A pop noise measurement method including:

a pop noise reproduction process of generating a silent shock wind; and

a sound acquisition process of acquiring pop noise generated by a shock wind generated in the silent shock wind generation process.

(11) The pop noise measurement method according to (10), wherein a plosive sound is divided into a sound part, and pop noise generated by a shock wind, and only the pop noise is acquired in the sound acquisition process of acquiring pop noise.

(12) A noise measurement device including:

a pop noise reproduction unit including at least a silent shock wind generator that generates a silent shock wind and a device for driving the silent shock wind generator; and

a sound acquisition unit that acquires noise generated by a shock wind generated by the silent shock wind generator.

(13) The pop noise measurement device according to (12), wherein the sound acquisition unit divides a plosive sound into a sound part and pop noise generated by a shock wind, and acquires only the pop noise.

(14) The pop noise measurement device according to (13), wherein the silent shock wind generator includes:

a speaker;

at least one speed-amplifying adaptor that increases the speed of a silent shock wind generated from the speaker;

a rectifier that rectifies the silent shock wind; and

an impedance adjuster that prevents the occurrence of an abnormal sound.

(15) A microphone including the pop noise reduction tool according to (1).

(16) The microphone according to (15), wherein the pop noise reduction tool is provided to cover the inside of a head case.

(17) The microphone according to (15), wherein the pop noise reduction tool is provided to cover a diaphragm without being in contact with the diaphragm.

(18) The microphone according to (15), wherein the microphone includes: a pop noise reduction tool which is provided to cover the inside of a head case; and another pop noise reduction tool which is provided to cover a diaphragm without being in contact with the diaphragm.

### Advantageous Effects of Invention

The pop noise reduction tool of the invention includes a sound-transmitting member having micropores that lead from one surface thereof to the other surface thereof and formed by fibers that are interlaced with each other, and the sound-transmitting member having a linear light transmittance of 20% or less. Therefore, the pop noise reduction tool of the present invention has a high pop noise reduction intensity compared with a pop noise reduction tool in the related art.

In particular, when the pop noise reduction tool is used as a filter unit, it is possible to provide a pop noise reduction tool having a high pop noise reduction intensity compared with a pop noise reduction tool in the related art.

Further, according to the pop noise reduction tool of the invention, since sound which is vibration of air can pass through the micropores, a total sound transmission performance is maintained and a shock wind which is a cause of pop noise can be effectively reduced, the pop noise reduction tool is particularly useful as a so-called sound lossless wind noise reduction tool having a reduction effect on low tone pop noise.

Since the microphone of the invention is provided with the pop noise reduction tool having the above-mentioned excellent features, it is possible to provide sound with reduced pop noise compared to that with a microphone in the related art.

Further, according to the pop noise measurement method and the noise measurement device of the invention, it is possible to systematically evaluate the influence of the sound acquisition unit with respect to a shock wind and the performance of the pop noise reduction tool.

### BRIEF DESCRIPTION OF DRAWINGS

FIG. 1 is a configuration example of a pop noise measurement device according to an embodiment of the invention.

FIG. 2 is a diagram illustrating a silent shock wind generator provided in the pop noise measurement device according to the embodiment of the invention.

FIG. 3 shows a graph (left) indicating a relationship between a relative sound pressure when a reference sound pressure in an initial part (a plosive sound “p” with a shock wind) when a voiced sound “pu” is uttered and a subsequent vowel part “u” is set to 1.0 and time, and a graph (right) indicating a relationship between a relative sound pressure with respect to the reference sound pressure in the initial part “p” and the subsequent vowel “u” and a frequency.

FIG. 4 is a graph illustrating a relationship between a relative voltage using a maximum allowable voltage as a reference and time, which shows data when waveform inspection for reproducing a situation close to a situation where an actual plosive sound is uttered is performed in the silent shock wind generator.

FIG. 5 is a front view and a sectional view illustrating a sound-transmitting member of a pop noise reduction tool according to an embodiment of the invention.

FIG. 6A is a diagram illustrating a preferable shape of the sound-transmitting member of the pop noise reduction tool according to the embodiment of the invention, which shows the sound-transmitting member seen in a direction perpendicular to a pop noise travel direction.

FIG. 6B is a diagram illustrating another preferable shape of the sound-transmitting member of the pop noise reduction tool according to the embodiment of the invention, which shows the sound-transmitting member seen in a direction perpendicular to a pop noise travel direction.

FIG. 7 is a diagram illustrating a device for checking a sound-transmitting feature of the pop noise prevention tool.

FIG. 8 is a sectional view illustrating an example of a case where the pop noise reduction tool according to the embodiment of the invention is attached to a microphone.

FIG. 9 is a sectional view illustrating another example of a case where the pop noise reduction tool according to the embodiment of the invention is attached to a microphone.

FIG. 10 is a sectional view illustrating still another example of a case where the pop noise reduction tool according to the embodiment of the invention is attached to a microphone.

FIG. 11 is a sectional view illustrating further still another example of a case where the pop noise reduction tool according to the embodiment of the invention is attached to a microphone.

FIG. 12 is a sectional view illustrating a microphone in the related art.

### DESCRIPTION OF EMBODIMENTS

Hereinafter, first, an embodiment of a pop noise reduction tool of the invention, and a microphone provided with the pop noise reduction tool will be described.

Sound-Transmitting Member

A linear light transmittance of a sound-transmitting member which is a component member of the pop noise reduction tool according to the embodiment of the invention is 20% or less, preferably 15% or less, and more preferably 10% or less. When the linear light transmittance exceeds 20%, the number or the size of through-holes increases, and thus, a shock wind easily escapes through an opposite surface of the sound-transmitting member, which results in an increase of pop noise. Further, even when the linear light transmittance is 0%, as long as micropores that lead from one surface to the other surface are reliably secured so that a whole sound transmission feature can be maintained, there is no problem.

Further, it is preferable that the sound-transmitting member be formed by a fiber material obtained by interlacing raw materials containing metallic fibers or resin fibers, and it is preferable that an air transmission rate thereof be less than 0.5 s/100 ml. With such properties, the sound transmission feature is remarkably enhanced.

The air transmission rate refers to a time necessary for a specific amount of air to pass through a specific area under a specific pressure. In this description, the air transmission rate refers to a time necessary for air of 100 ml to pass through a sheet-shaped sound-transmitting member. The air transmission rate may be measured by a Gurley method regulated in JIS P8117.

Further, since the sound-transmitting member is a fiber material obtained by interlacing raw materials containing fibers, the sound-transmitting member has countless irregular pores. Accordingly, the sound-transmitting member exhibits a whole sound transmission feature with respect to sound which is air vibration. On the other hand, a sound-transmitting member of which the linear light transmittance is 20% or less due to interlacing of fibers exhibits a wind-blocking feature like a non-porous plate with respect to a sudden shock wind when a plosive sound such as p, t, or k which is a cause of pop noise is generated.

That is, the pop noise reduction tool according to the embodiment of the invention that includes, as a component, the sound-transmitting member in which micropores that lead from one surface to the other surface are formed, fibers are interlaced with each other, and the linear light transmittance is 20% or less exhibits an effective wind noise elimination performance with respect to a so-called steady wind such as a natural wind that blows under a specific pressure or an air-conditioning drift, and particularly, also functions as a shield with respect to a “shock wind” which is a sudden movement of the cluster of air molecules. Further, the pop noise reduction tool has a feature of an approximately perfect transmittance with respect to “sound” which is a movement of a pressure change (in which a medium itself only vibrates and does not move).

The micropores that lead from one surface to the other surface include a case where although it is not possible to confirm the existence of the micropores at a glance due to complicated interlacing of fibers, there are pores that lead from one surface to the other surface even along complicated paths. With respect to the micropores, it is possible to confirm the existence of pores by a bubble point method (which will be described later), and to measure a maximum pore diameter.

The sound-transmitting member is formed by interlacing fibers with each other. For example, a fiber material in which fibers are interlaced with each other is obtained by performing paper-making by a wet paper making method. In this embodiment, raw materials used for manufacturing the fiber material are metallic fibers or fluorine fibers. Further, a fiber member used as the sound-transmitting member has a thickness of 3 mm or less, preferably 10 μm to 2,000 μm, and more preferably 20 μm to 1,500 μm. With such a thickness, it is possible to obtain an effective pop noise reduction effect using a minimized and simple configuration having a certain degree of stiffness.

Here, the raw materials of the fiber material are not limited to the metallic fibers or the fluorine fibers, and the thickness thereof is not limited to the above-described numerical values.

A maximum pore diameter of the pores in the sound-transmitting member is 1 gm or greater and 2,000 μm or less, preferably 30 μm or greater and 500 μm or less, and more preferably 50 μm or greater and 300 μm or less. If the maximum pore diameter is equal to or greater than the lower limit, it is possible to easily manufacture the sound-transmitting member with relatively low cost. If the maximum pore diameter is equal to or less than the upper limit, it is difficult to recognize opening portions when a user comes to close to the sound-transmitting member of the metallic fibers, which is preferable in view of a fine appearance.

Further, it is preferable that the number of through-hole portions that lead from one surface to the other surface be small.

Next, a metallic fiber material which is a raw material of a fiber material will be described.

In the metallic fiber material, metallic fibers are interlaced. Further, each metallic fiber has a fiber diameter of 1 μm to 50 μm, preferably 2 μm to 40 μm, and more preferably 8 μm to 30 μm. These metallic fibers are suitable for interlacing the metallic fibers. Further, by interlacing these metallic fibers, it is possible to obtain a metallic fiber sheet in which fuzz of the surface is small and a sound transmission feature and a pop noise reduction feature are achieved together. The shape of the metallic fiber material is not particularly limited, but preferably, has a metallic fiber sheet.

One or more types of metallic fibers which form the metallic fiber material refer to one type of fibers or a combination of two or more types of fibers selected from fibers formed of metallic materials such as stainless, aluminum, brass, copper, titanium, nickel, gold, platinum, and lead.

The metallic fiber material may be obtained by paper-making slurry including one or more types of metallic fibers by a wet paper making method.

A method of manufacturing the metallic fiber material using the wet paper making method includes a fiber-interlacing process of interlacing metallic fibers that form a sheet containing net-like moisture when forming the slurry to the sheet by the wet paper making method.

Here, as the fiber-interlacing process, for example, it is preferable that a fiber-interlacing process of ejecting a high-pressure jet water stream onto the surface of the metallic fiber sheet after paper making be used. Specifically, by arranging plural nozzles in a direction perpendicular to a flowing direction of the sheet, and by simultaneously ejecting high-pressure jet water streams from the plural nozzles, it is possible to interlace the metallic fibers over the entire sheet.

That is, by ejecting the high-pressure jet water streams onto the sheet formed by the metallic fibers which irregularly intersect with each other in a surface direction by the wet paper making in a Z axis direction, for example, the metallic fibers at portions where the high-pressure jet water streams are ejected are orientated in the Z axis direction. The metallic fibers orientated in the Z axis direction are entangled between the metallic fibers irregularly orientated in the surface direction, and thus, it is possible to obtain a state where the respective fibers are entangled in a three-dimensional pattern, that is, are interlaced with each other, to thereby secure a physical strength.

Further, as the paper making method, for example, various methods such as Fourdrinier paper making, circular paper making, or inclined wire paper making may be used as necessary. In a case where slurry including long metallic fibers is used, since dispersibility of the metallic fibers in water may deteriorate, a small amount of a polymer aqueous solution such as polyvinyl pyrrolidone, polyvinyl alcohol, or carboxymethyl cellulose (CMS) with a thickening property may be added thereto.

Further, the metallic fiber material may be obtained by applying heat and pressure to a metallic fiber aggregate.

In a method of manufacturing the metallic fiber material using compression molding, first, fibers are collected and are preliminarily compressed, for example, to form a web. Alternatively, a binder is impregnated between the fibers to assign coupling between the fibers, and then, the fibers are preliminarily compressed, for example. Then, the metallic fiber aggregate is heated and pressed to obtain a metallic fiber sheet.

Such a binder is not particularly limited, but for example, an organic binder such as an acrylic adhesive, an epoxy adhesive, or a urethane adhesive may be used, or an inorganic adhesive such as colloidal silica, water glass or sodium silicate may be used. The amount of the impregnated binder is preferably 5 to 130 g, and more preferably 20 to 70 g when a plane weight of the sheet is 1,000 g/m².

In a case where the binder is impregnated by a spray method, it is preferable that a metallic fiber layer be formed with a predetermined thickness through press working or the like before a spray process.

Further, instead of the impregnation of the binder, a fiber surface may be coated with a thermal adhesive resin in advance, and then, a metallic fiber aggregate may be laminated, and may be heated for bonding.

Then, the metallic fiber aggregate is heated and pressurized to form a sheet. Heating conditions are set in consideration of a drying temperature or a curing temperature of a binder or a thermal adhesive resin to be used, but a heating temperature is usually about 50° C. to 1,000° C.

The applied pressure is adjusted in consideration of an elasticity of fibers, a thickness of a sound-transmitting member, and a light transmittance of the sound-transmitting member.

Further, it is preferable that the manufacturing method of the metallic fiber material include a sintering process of sintering the metallic fiber material obtained after the above-described wet paper making process at a temperature which is equal to or lower than a melting point of the metallic fibers in a vacuum atmosphere or in a non-oxidizing atmosphere (in the case of compression formation, heating and pressurizing are performed instead of the sintering process). That is, if the sintering process is performed after the above-described wet paper making process, since a fiber interlacing fixing process is performed, it is not necessary to add an organic binder or the like to the metallic fiber material. Thus, a decomposition gas such as an organic binder does not occur as an obstacle in the sintering process, and thus, it is possible to manufacture a metallic fiber material having a glossy surface specific to metal. In addition, since metallic fibers are interlaced, it is possible to enhance the strength of a metallic fiber material after sintering. Furthermore, by sintering a metallic fiber material, it is possible to obtain a material that exhibits a high sound transmission feature, a high pop noise reduction feature, and an excellent waterproof feature. In a case where sintering is not performed, the remaining polymer having a thickening action absorbs water, which deteriorates the waterproof feature.

As the metallic fiber material, and its manufacturing method, methods disclosed in Japanese Unexamined Patent Application, First Publication No. 2000-80591, Japanese Patent Publication No. 2649768, and Japanese Patent Publication No. 2562761 may be used instead of the above-described method.

Next, a fluorine fiber material which is a raw material of a fiber material will be described.

In a sound-transmitting member formed of a fluorine fiber material, fluorine fibers of a short fiber shape which are orientated in irregular directions are coupled by thermal bonding.

The fluorine fibers are manufactured from a thermoplastic fluororesin, and as its main component, polytetrafluoroethylene (PTFE), tetrafluoroethylene (TFE), perfluoro ether (PFE), a copolymer of tetrafluoroethylene and hexafluoropropylene (FEP), a copolymer of tetrafluoroethylene and ethylene or propylene (ETFE), vinylidene fluoride resin (PVDF), polychlorotrifluoroethylene resin (PCTFE), or vinyl fluoride resin (PVF) are used, but the invention is not limited thereto, and any different material made of a fluororesin may be used. Further, the different material may be used as a mixture with the former materials or other resins.

In order to form the fluorine fiber in a paper shape by the wet paper making method, it is preferable that the fluorine fiber be a single fiber having a length of 1 mm to 20 mm, and that its diameter be 2 μm to 30 μm.

The fluorine fiber material may be manufactured by thermally compressing a fluorine fiber mixed paper material obtained by mixing fluorine fibers and a material having a self-adhesive function by a wet mixing method and drying the resultant at a temperature which is equal to or higher than a softening point of the fluorine fibers so that the fluorine fibers are thermally bonded, by dissolving and removing the material having the self-adhesive function using a solvent, and by drying the resultant again as necessary.

Here, as the material having the self-adhesive function, natural pulp made from plant fibers such as wood, cotton, hemp, or straw normally used as a paper making material, synthetic pulp or synthetic fibers made of polyvinyl alcohol (PVA), polyester, aromatic polyamide, or thermoplastic acrylic synthetic polymer, synthetic pulp or synthetic fibers made of polyolefin-based thermoplastic synthetic polymer, a paper-strengthening agent for paper-making made of natural polymer or synthetic polymer, or the like may be used, but the invention is not limited thereto, and any other material having a self-adhesive function capable of being mixed with the fluorine fibers and capable of being dispersed into water may be used.

Instead of the above-described manufacturing methods, as the fluorine fiber material and the manufacturing method thereof, a method disclosed in Japanese Unexamined Patent Application, First Publication No. S63-165598 may be used.

Next, configurations of the pop noise reduction tool and the microphone provided with the pop noise reduction tool will be described.

As long as the sound-transmitting member can reduce pop noise, for example, through-holes may be appropriately opened in a peripheral part of a circular sound-transmitting member.

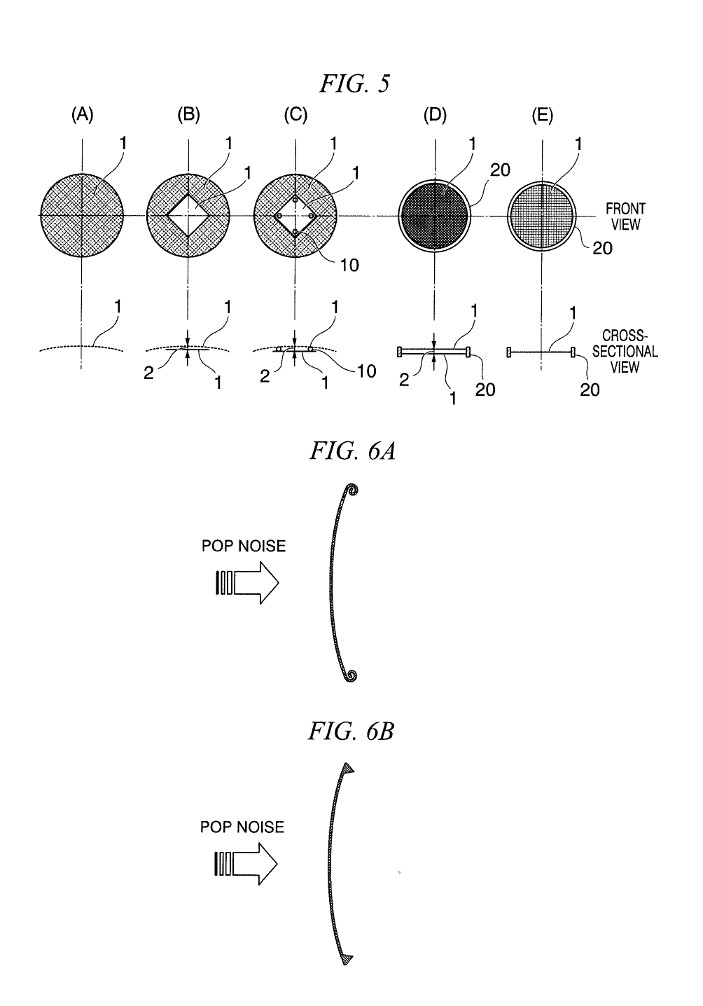

Since it is sufficient if the pop noise reduction tool according to the embodiment of the invention includes a sound-transmitting member having the above-described features without reducing the effects of the invention, the pop noise reduction tool includes a case where only one sound-transmitting member 1 is provided as shown in FIG. 5A, a case where two sound-transmitting members 1 and 1 are attached to each other as shown in FIG. 5B, two sound-transmitting members 1 and 1 are attached by a vibration-proof material 10 as shown in FIG. 5C, a case where two sound-transmitting members 1 and 1 are attached to a frame 20 and as shown in FIG. 5D, a case where one sound-transmitting member 1 is attached to a frame 20 as shown in FIG. 5E, and a case where a fixing member is attached to be able to fixed to a microphone stand or the like.

FIGS. 5B, 5C, and 5D show examples in which two sound-transmitting members are provided. In this case, it is preferable that a distance between the centers of the sound-transmitting members be in a range of 2 mm to 50 mm If the distance between the centers is 2 mm or greater, the sound-transmitting members can exhibit sufficient effects. Further, in a case where a normal usage environment is considered, it is preferable that the distance between the centers be 50 mm or less. Specifically, in order to attach the sound-transmitting member to a microphone or the like, it is preferable that the distance between the centers be 50 mm or less.

The distance between the centers of the sound-transmitting members refers to, in a case where one sound-transmitting member is flat and the other sound-transmitting member has a curved surface as shown in FIGS. 5B and 5C, a distance Z between a central portion of the flat sound-transmitting member and a central portion of the sound-transmitting member having the curved surface. As shown in FIG. 5D, in a case where two sound-transmitting members are flat, the distance between the centers of the sound-transmitting members refers to a distance Z between central portions of the flat sound-transmitting members.

Further, in the pop noise reduction tool according to the embodiment of the invention, it is preferable that an edge portion of the sound-transmitting member be rounded as shown in FIG. 6A, or be provided with a flange as shown in FIG. 6B. In FIG. 6B, a cross section of the flange is triangular, but the invention is not limited thereto. The cross section of the flange may be circular, rectangular, or polygonal.

In this way, if the edge portion of the sound-transmitting member is rounded or is provided with a flange, it is possible to efficiently rectify a shock wind to flow into a region where a microphone is not present from an edge portion of the pop noise reduction tool. Further, it is possible to prevent generation of noise in the edge portion of the pop noise reduction tool, to thereby further reduce pop noise.

In particular, in a case where the surface of the sound-transmitting member is a curved surface, it is possible to more effectively rectify a shock wind.

The pop noise reduction tool according to the embodiment of the invention may be attached to a microphone. FIG. 12 is a sectional view illustrating a microphone in the related art, that is, a microphone in which the pop noise reduction tool of the invention is not attached.

The related art microphone is schematically configured by a diaphragm 30 which is a vibration plate that receives sound, a coil 31 that transmits vibration obtained by the diaphragm, a head case 32 that accommodates the diaphragm 30 and the coil 31, and a pop guard 101 formed of cotton or the like, provided inside the head case.

On the other hand, FIGS. 8 to 11 are sectional views illustrating microphones provided with the pop noise reduction tool according to the embodiment of the invention.

In the microphone shown in FIG. 8, the pop noise reduction tool (sound-transmitting member) 1 according to the embodiment of the invention is attached to a fixture 33 so as not to be in contact with the diaphragm 30 and so as to cover the diaphragm 30. The fixture 33 is formed of a material that does not transmit vibration of the pop noise reduction tool (sound-transmitting member 1) to the diaphragm 30. Further, a structure in which vibration is not transmitted to the diaphragm 30 may be used.

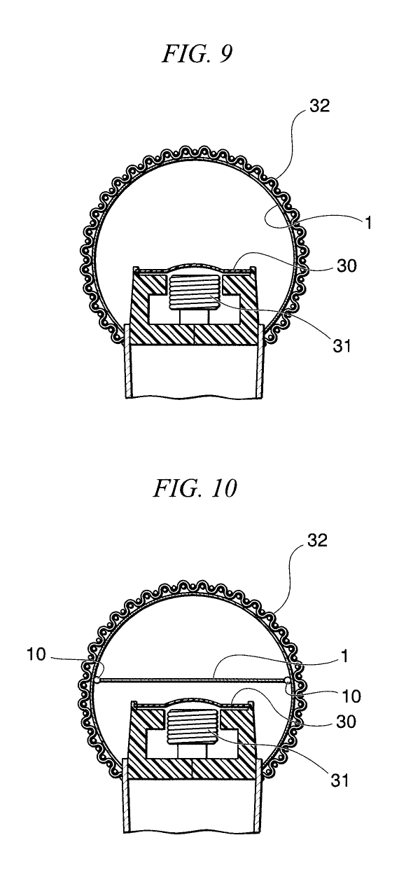

In the microphone shown in FIG. 9, a microphone wind shield 101 which is formed of sponge or the like in the related art and is attached to cover the inside of the head case 32 is replaced with the pop noise reduction tool (sound-transmitting member 1) according to the embodiment of the invention.

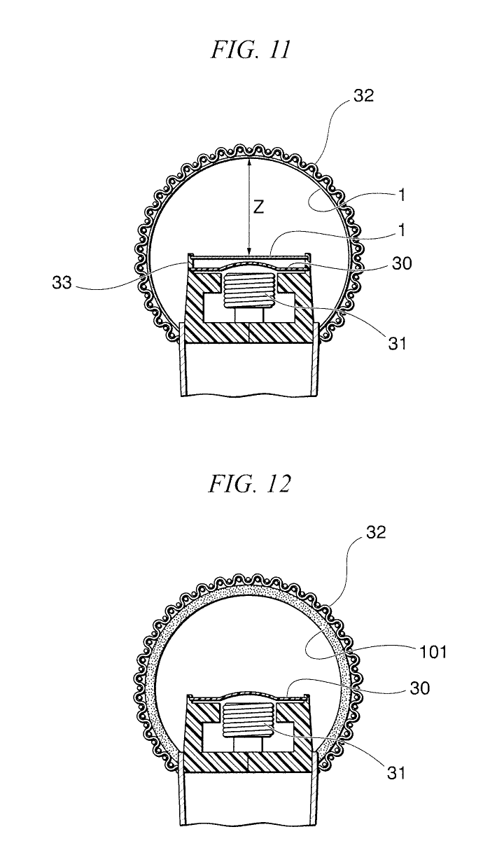

In the microphone shown in FIG. 10, the pop noise reduction tool (sound-transmitting member 1) according to the embodiment of the invention is attached to a part of an inner surface of the head case 32 through the vibration-proof material 10 so as not to be in contact with the diaphragm 30 and so as to cover the diaphragm 30. That is, in the microphone shown in FIG. 10, the fixture 33 for the pop noise reduction tool 1 is not provided.

Further, the microphone shown in FIG. 11 is obtained by combining the pop noise reduction tools according to the embodiment of the invention shown in FIGS. 8 and 9. That is, the microphone shown in FIG. 11 includes the pop noise reduction tool (sound-transmitting member 1) attached so as not to be in contact with the diaphragm 30 and so as to cover the diaphragm 30, and the pop noise reduction tool (sound-transmitting member 1) attached to cover the inside of the head case.

As shown in FIG. 11, in the case of the microphone that uses two pop noise reduction tools, as described above, it is preferable that a distance between the centers of the two pop noise reduction tools be in a range of 2 mm to 50 mm

In this specification, the “microphone” means a microphone of a so-called product form including a member that performs a sound acquisition function of the microphone, a housing, and a protective member. Further, a “microphone unit” means a set of members that perform a sound acquisition function.

Further, in a case where the pop noise reduction tool according to the embodiment of the invention is used as a microphone wind shield, in order to maintain the sound transmission feature, it is important to take a processing method that does not crush micropores. If this requirement is satisfied, any known method may be used as the processing method, but it is preferable that deep drawing be used.

In a case where the pop noise reduction tool is attached to a fixing member, it is preferable that vibration-proofmg be secured. Due to the vibration-proofing, it is possible to reduce additional sound (scratching sound or resonance sound) generated when a shock wind collides with the sound-transmitting member, a microphone stand that supports the sound-transmitting member, or the like.

It is preferable that the vibration-proof material be formed of a rubber-shaped elastic member, but the invention is not limited thereto, and any material capable of reducing the additional sound may be used. Further, for the same purpose, a weight (additional mass or blocking mass) may be attached to the sound-transmitting member.

The number of pop noise reduction tools arranged between a plosive sound utterance source and the microphone unit is not limited, and thus, may be selected in consideration of the pop noise reduction effect and economic efficiency.

In a case where plural pop noise reduction tools according to the embodiment of the invention are arranged, it is preferable that a distance between sound-transmitting members be set to 2 mm to 50 mm. In a case where the distance between the pop noise reduction tools is too short, a risk that additional sound occurs becomes high. On the other hand, in a case where the distance is too long, since a distance between a sound source and a microphone is distantly separated, a restriction that an S/N ratio is reduced or recording using a proximity effect is impossible occurs.

Pop noise measurement method and noise measurement device

Hereinafter, an embodiment of a pop noise measurement method and a noise measurement device of the invention will be described with reference to the accompanying drawings. In this embodiment, an example in which a speaker is used as a silent shock wind generation source will be described. However, in implementation and productization, any device or any apparatus capable of realizing approximately the same piston movement as that of the speaker in silence may be selected.

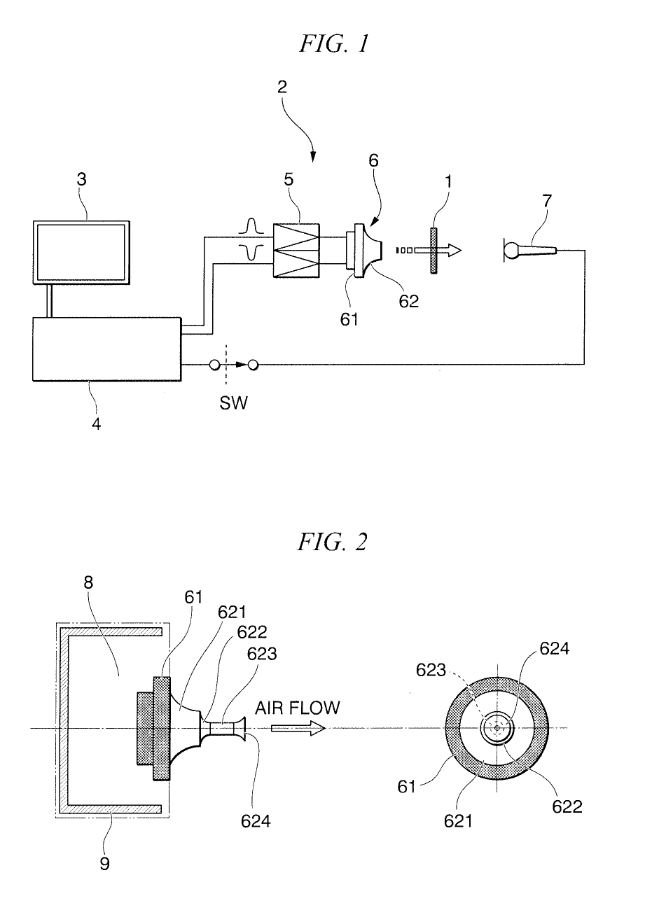

Further, in the following description, a right side in FIG. 1 or 2 may be referred to as an X side, and a left side thereof may be referred to as a −X side.

Pop noise is generated when a microphone unit detects a shock wind (air movement) from an immediately near wind source differently from a voiced sound. Since the shock wind is a wind from the immediately near wind source, the shock wind is different from a natural wind, or a fan wind of an indoor air-conditioner, a fan or the like.

That is, in order to stably measure pop noise by reproducing a shock wind, requirements of silence with only air movement and sudden occurrence of the air movement should be satisfied. Accordingly, in a shock wind generator, sufficient responsiveness and controllability with respect to a driving source and no occurrence of noise such as a device driving sound which is an obstacle in noise measurement or an abnormal sound due to a shock wind should be satisfied

The plosive sound such as p, t, or k generating pop noise includes an outer plosive sound generated in a breathing-out process, that is, three stages of closure formation→duration→opening, and an inner plosive sound generated in a great breathing-in process. Here, a cause for generating pop noise in a microphone is mainly the former, that is, the outer plosive sound corresponding to the silent plosive sound such as p, t, or k, which is particularly noticeable in a singing microphone or a condenser microphone having directionality.

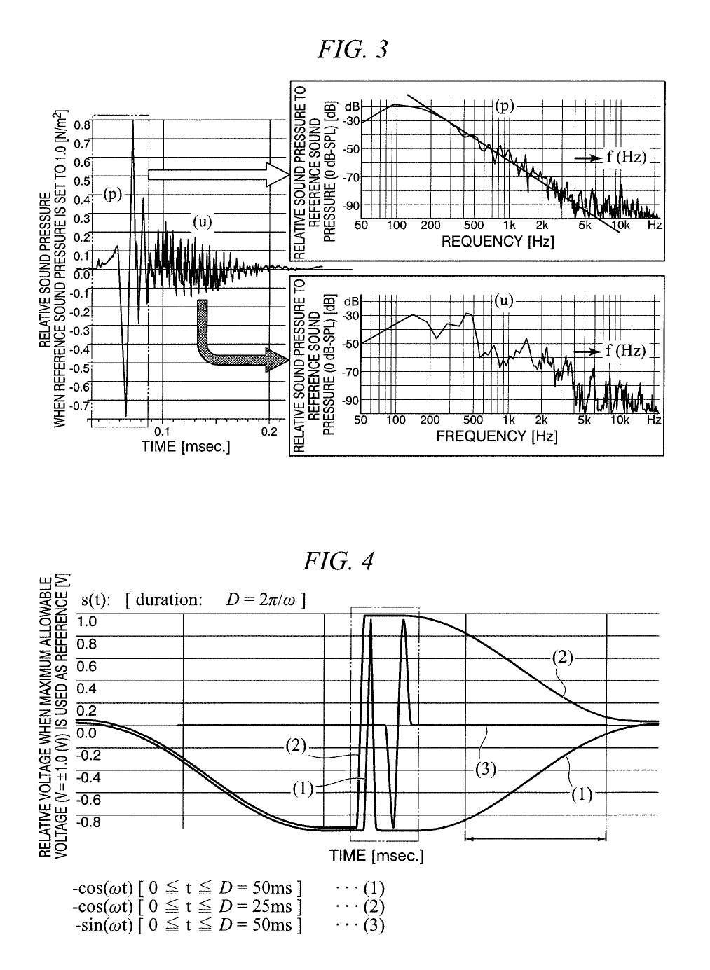

FIG. 3 shows frequency spectra (maximum FFT values every 10 ms) of an initial part (a plosive sound “p” with a shock wind) and a subsequent vowel part “u” when a voiced sound “pu” is uttered at a place of 50 mm in front of a condenser microphone. A spectrum marked with a sign “u” in FIG. 3 corresponds to a vowel formant having plural peaks. On the other hand, a spectrum marked with a sign “p” corresponds to a maximum slope part of a vowel “p”, which becomes noise attenuated at a fixed rate before and after 10 dB/Oct to 15 dB/Oct, that is, pop noise. The silent shock wind generator needs to generate the spectrum of these parts with accuracy and with high reproducibility.

FIG. 1 is a configuration diagram illustrating a noise measurement device. A noise measurement device 2 includes a controller 3 for controlling a silent shock wind generator, a DC-coupled sound card 4, a DC power amplifier 5, a silent shock wind generator 6, and a sound acquisition unit 7.

The controller 3 transmits an electric signal for driving the silent shock wind generator 6, and processes a signal for each frequency transmitted from the sound acquisition unit 7 through the DC-coupled sound card 4. Normally, the controller 3 may employ a general PC.

The DC-coupled sound card 4 converts an electric signal transmitted from the controller 3 into an analog signal (a sine wave or the like) for driving the silent shock wind generator 6, and transmits the converted signal to the DC power amplifier 5.

The DC power amplifier 5 amplifies the analog signal transmitted from the DC-coupled sound card 4. Thus, it is possible to generate a sufficient shock wind suitable for pop noise reproduction from the silent shock wind generator 6.

FIG. 2 is a diagram illustrating details of the silent shock wind generator 6. In the figure, the left side is a side view, and the right side is a view of the silent shock wind generator 6 seen from an opening end side thereof. Since the silent shock wind generator 6 satisfies the requirements of sufficient responsiveness and controllability with respect to a driving source and no occurrence of noise such as a device driving sound which is an obstacle in noise measurement or an abnormal sound due to a shock wind, the configuration as shown in FIG. 2 is obtained. However, as long as the requirements are satisfied, any configuration may be used.

As shown in FIG. 2, a first speed-up adaptor 621 (a first speed-increasing portion) and a second speed-up adaptor 622 (a second speed-increasing portion) of approximately trapezoidal shapes formed to be continuously thinned in tube diameter so as not to generate an abnormal sound are provided on an opening surface of a high-compliance roll edge speaker 61 enabling driving at a sufficient amplitude. Thus, a silent shock wind generated from the high-compliance roll edge speaker 61 is increased in speed by the first speed-up adaptor 621 and the second speed-up adaptor 622, and then, is discharged to the X side.

Here, JA0801 made by Yamaha Corp. is used as the high-compliance roll edge speaker 61, but the invention is not limited thereto, and any speaker capable of securing sufficient driving for generating a silent shock wind may be used.

Further, as materials of the first and second speed-up adaptors, any material may be used as long as no abnormal sound occurs, and for example, a rigid material such as metal or plastic may be used.

In addition, a pipe 623 which is a straight pipe for rectification may be provided as necessary.

Furthermore, in order to prevent the occurrence of an abnormal sound, a mechanical impedance-adjusting member 624 may be provided on an opening end side of the pipe 623.

A total length of the pipe 623 and the mechanical impedance-adjusting member 624 depends on a speaker diameter and a lower limit frequency to be measured, but it is preferable that the total length be 10 mm to 50 mm.

A speaker box 8 and a glass wool member 9 which is a sound-absorbing material are provided to prevent an air flow generated on a rear side from reversely flowing to the side of the sound acquisition unit 7, but if the existence of such a phenomenon is not recognized, it is not necessary to provide the speaker box 8 and the glass wool member 9.

With such a configuration, it is possible to generate a silent shock wind in which a sound part is eliminated from a plosive sound having a bundle diameter of about 50 mm and a wind speed of several meters per second to several tens of meters per second at a place distant from the opening end of the silent shock wind generator 6 by 100 mm

The sound acquisition unit 7 is not particularly limited to a specific unit, and a target acquisition unit to be inspected and measured may be provided in consideration of the influence of noise due to a shock wind and a reduction solution thereof

Hereinafter, an operation of the noise measurement device according to the embodiment of the invention having the above-described configuration, and a noise measurement method will be described.

First, a driving signal of the silent shock wind generator 6 is determined in view of the following points.

Sine wave and cosine wave signals (1), (2), and (3) as shown in FIG. 4 are applied to the silent shock wind generator 6 through the DC power amplifier 5.

In consideration of closure formation→duration→opening which is an actual generation process of voice, it is considered that a waveform of (2) is closest to the voice generation process. However, either the signal (2) or the signal (3) may be used.

Here, if a signal continuation time is too short, noise is generated as a shock sound, and if it is too long, a shock wind based on a plosive sound cannot be reproduced. Accordingly, as the signal continuation time of either the signal (2) or the signal (3), it is important that an optimal value suitable for the purpose of measurement and evaluation be selected from a range of 20 msec to 100 msec.

Further, if the signal continuation time of a sine wave-increasing portion is 25 msec or less, an abnormal sound is generated at the opening end of the silent shock wind generator 6, and when it is 100 msec or greater, the wind speed becomes insufficient. Accordingly, noise is measured in a range where the signal continuation time is 25 msec from a sine wave-increasing portion close to an utterance situation (in FIG. 4, a sine wave in a range surrounded by a two-dotted chain line), marked with reference numeral (2) in FIG. 4 (which is hereinafter referred to as a reference measurement condition).

Next, an operation of the noise measurement device and a noise measurement method will be described.

A signal for driving the silent shock wind generator 6 is applied to the DC power amplifier 5 from the controller 3 through the DC-coupled sound card 4. A speaker cone of the high-compliance roll edge speaker 61 of the silent shock wind generator 6 gradually moves to the −X side in the left view of FIG. 2, and then, returns to the X side at once, to thereby radiate a silent shock wind.

The radiated silent shock wind is increased in speed by the first speed-up adaptor 621 and the second speed-up adaptor 622, and then, is discharged to the X side. The silent shock wind discharged into the X side reaches the sound acquisition unit 7. Pop noise detected by the sound acquisition unit 7 is converted into an electric signal, is returned to the controller 3 for the silent shock wind generator, and is recorded as pop noise for each frequency.

In this way, it is possible to inspect the influence of pop noise on a sound acquisition unit which is a measurement target.

Further, by providing the pop noise reduction tool between the silent shock wind generator 6 and the sound acquisition unit 7 or attaching the pop noise reduction tool as a wind shield of the sound acquisition unit, it is possible to measure the degree of reduction of pop noise. In addition, by providing a steady wind generator such as an electric fan instead of the silent shock wind generator 6, it is possible to measure wind noise with respect to a steady wind such as an air-conditioning draft or an outdoor natural wind.

### EXAMPLES

Hereinafter, examples and comparative examples with respect to the pop noise reduction feature of the pop noise reduction tool according to the embodiment of the invention will be described. The invention is not limited to these examples.

Further, it is assumed that the pop noise reduction tool is basically provided between the silent shock wind generator 6 which is a wind source and the microphone unit of the sound acquisition unit 7.

### Example 1

Manufacturing of metallic fiber sound-transmitting member

A flocculating web was made by superposing fibers of a wire diameter of 30 μm made of stainless AISI316 to become uniform. The web was weighted to have a total weight of 950 g/m², and was compressed to have a thickness of 800 μm between flat plates. By putting the compressed and plate-shaped web into a sintering furnace, and heating the web at a temperature of 1100° C. under a vacuum atmosphere, a sintered sound-transmitting member was obtained.

An interval between the opening end of the mechanical impedance-adjusting member 624 of the silent shock wind generator 6 provided in the pop noise measurement device 2 shown in FIG. 2 and the sound acquisition unit 7 was set to 50 mm. Then, in a case where the pop noise reduction tool is provided so that one sound-transmitting member is arranged in a direction perpendicular to a traveling direction of a silent shock wind at a middle point therebetween (25 mm from the sound acquisition unit 7), and in a case where the pop noise reduction tool is not provided, a pop noise attenuation was measured under the reference measurement condition. FIG. 5A shows a front view and a sectional view of the sound-transmitting member.

### Example 2

As the pop noise reduction tool, a pop noise attenuation was measured in a similar way to Example 1, except that two sound-transmitting members made in Example 1 were arranged so that a distance between the centers thereof became 3 mm, as shown in FIG. 5B.

### Example 3

A pop noise attenuation was measured in a similar way to Example 1, except that the same sound-transmitting member as in Example 1 was molded into a wind shield form of the sound acquisition unit 7 by deep drawing, was attached as a wind shield of the sound acquisition unit 7, and was used as a pop noise reduction tool. That is, in this example, the pop noise reduction tool shown in FIG. 9 was obtained.

### Example 4

A pop noise attenuation was measured in a similar way to Example 1, except that a vibration-proof material 10 was attached to a portion where two sound-transmitting members contact each other, as shown in FIG. 5C, in a pop noise reduction tool.

### Example 5

Manufacturing of Fluororesin Fiber Sound-Transmitting Member

Thermoplastic fluororesin fibers (Aflon COP manufactured by Asahi Glass Co., Ltd., 10 φmφ×11 mm product used) of 80 parts by weight, made of copolymer of tetrafluoroethylene and ethylene and NBKP of 20 parts of a beating degree of 40° SR were dispersed and mixed in water to obtain a raw material of the fluororesin fiber sound-transmitting member. Then, a betaine-type amphoteric surfactant (manufactured by Daiwa chemical industries Co., Ltd. Desgran B used) was added to the obtained raw material (addition with respect to fluorine fibers and pulp, which is similarly applied hereinafter) by 0.5% by weight, and was disaggregated using an agitator. Then, an acrylamide dispersing agent (Acryperse PMP manufactured by Diafloc Co., Ltd.) was added to the raw material by 1% by weight, was made to a sheet using a TAPPI standard sheet machine, and was dried to obtain a fluorine fiber-mixed paper of a weight of 115 d/g. Then, the fluorine fiber-mixed paper was heated and pressurized at a temperature of 220° C. and at 10 kg/cm², for 20 minutes, and was immersed in a 98% H₂SO₄ solution at room temperature to dissolve the pulp component in the fluorine fiber-mixed paper. Then, the resultant was washed and dried again to obtain a sound-transmitting member of a thickness of 250 μm.

A pop noise attenuation was measured in a similar way to Example 1, except that the sound-transmitting member as manufactured above was used as a pop noise reduction tool.

### Example 6

Manufacturing of Metallic Fiber Sound-Transmitting Member

Slurry made of stainless steel fibers of a fiber length of 4 mm and a fiber diameter of 8 μm (Sasumic manufactured by Tokyo Rope Mfg. Co., Ltd.) by 60 parts by weight, copper fibers of a fiber length of 4 mm and a fiber diameter of 30 μm (Capron manufactured by ESCO) by 20 parts by weight, and PVA fibers of a solubility in water of 70° C. (Fibribond VPB 105-1-3 manufactured by Kuraray Co., Ltd.) by 20 parts by weight was subjected to dewatering pressing by a wet paper making method, and was heated and dried to obtain a metallic fiber sheet of 100 g/m². The obtained sheet was heated and pressed under the conditions of a line pressure of 300 kg/cm and a speed of 5 m/min using a heating roll of 160° C. Then, the pressed metallic fiber sheet was sintered using a continuous sintering furnace at a heat treatment temperature of 1,120° C. and a speed of 15 cm/min under a hydrogen gas atmosphere (a mesh belt brazing furnace) without being pressurized, to thereby obtain a sound-transmitting member having a thickness of 45 μm, a basis weight of 80 g/m², and a density of 1.69 g/cm³, in which copper was fused and coated on the surface of each stainless steel fiber.

A pop noise attenuation was measured in a similar way to Example 1, except that the sound-transmitting member as manufactured above was used as a pop noise reduction tool.

### Comparative Example 1

A pop noise attenuation was measured in a similar way to Example 1, except that ST-POP manufactured by SONTRONICS, which was an elastic fiber pop filter of a type shown in FIG. 5D, was used as a pop noise reduction tool.

### Comparative Example 2

A pop noise attenuation was measured in a similar way to Example 1, except that PROSCREEN101 manufactured by STEDMAN, which was an expanded metal of a type shown in FIG. 5E, was used as a pop noise reduction tool.

### Comparative Example 3

A pop noise attenuation was measured in a similar way to Example 1, except that the ST-POP manufactured by SONTRONICS used in Comparative Example 1 was arranged on a wind source side and PROSCREEN101 manufactured by STEDMAN used in Comparative Example 2 was arranged on a sound acquisition unit side with a middle point between the opening end of the mechanical impedance-adjusting member 624 and the sound acquisition unit 7 being interposed therebetween.

Measurement Method

(1) Confirmation of Whole Sound Transmission Feature

“The whole sound transmission feature is present” in this description is defined as properties of a material capable of transmitting approximately whole sound energy at main sound frequency bands (300 Hz to 3.5 kHz) regardless of incident directions.

Specifically, a case where an amplitude feature difference (sound pressure difference) between a case where there is a sample and a case where there is no sample is within 2 dB to 3 dB in a measured frequency band, at an incident angle of 0° or at an angle after transmission (by a reciprocity law) measured by a method to be described later, is determined as “the whole sound transmission feature is present”.

(2) Evaluation of Sound Transmission Feature

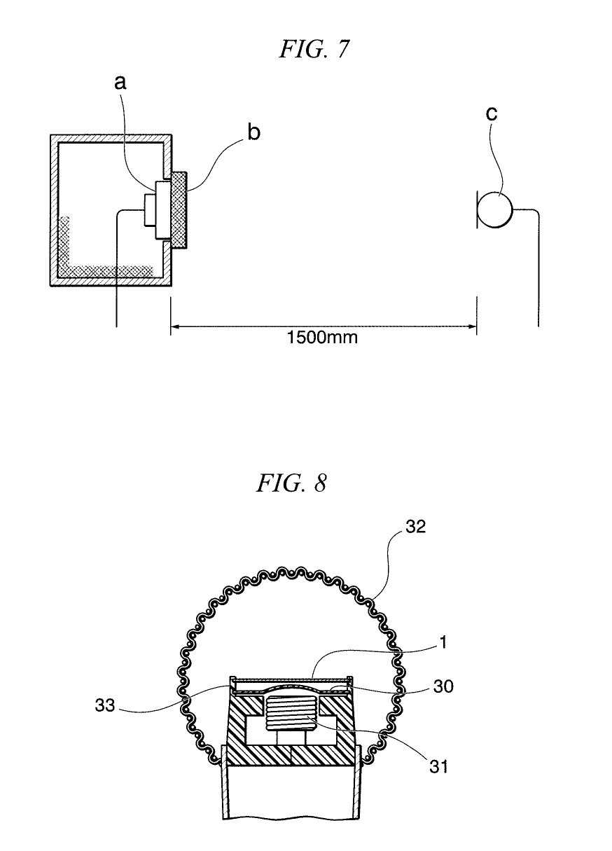

As shown in FIG. 7, a continuous sine wave sweep sound was discharged from a sound generator of about 2,250 cm³ to which a speaker a having an effective diameter of ten and more centimeters was provided, and a pop noise reduction tool b of each example and each comparative example was provided on a front surface of the sound generator. Then, a sound pressure for each frequency measured in a microphone c provided at a position of about 1,500 mm from the front surface of the speaker a was recorded using a level recorder or the like.

In the state, a change of the sound pressure in a case where the pop noise reduction tool b is present and a case where the pop noise reduction tool b is not present was measured and confirmed as an insertion loss Δ (dB). As a source of sound discharged from the speaker a, a continuous sine wave sweep signal which is not subjected to frequency modulation, ranging from 20 Hz to 20 kHz, was used. The sound used herein was 20 dB or higher in S/N ratio with respect to background noise. The insertion loss was calculated as an absolute value by the following expression.

Insertion loss Δ(dB)=|frequency response (dB) when there is no sample−frequency response (dB) when there is a sample|

Then, the sound transmission feature was evaluated on the basis of obtained data as follows.

Through each 1/1 octave band of a central frequency of 63 Hz to 8 kHz, in a case where the insertion loss Δ (dB) was within 2 dB, the feature was determined to be “excellent”. In a case where a measurement value was present within 5 dB, the feature was determined to be “slightly poor”, and in a case where a measurement value exceeded 5 dB, the feature was determined to be “poor”.

(3) Confirmation of Presence or Absence of Micropores

The presence or absence of micropores of the sound-transmitting member that forms the pop noise reduction tool according to the embodiment of the invention and a maximum pore diameter thereof were calculated using the following bubble point method.

Bubble Point Method

Measurement Using Palm Porometer (Manufactured by Seika Corporation)

A sample was immersed in isopropyl alcohol. When the pressure of air was gradually increased from the bottom and reached a certain value, bubbles were generated from pores of a maximum pore diameter. The pressure at this time is referred to as a bubble point pressure. Then, the maximum pore diameter was calculated using the following expression. The measurement result is shown in Table 1.

D_{BP}=4γ cos θ/P [Expression 1]

D_{BP}: maximum pore diameter [m]

γ: surface tension of sample solution [N/m]

θ: contact angle [rad]

P: bubble point pressure [Pa]

(4) Measurement of Linear Light Transmittance

The pop noise reduction tool was set in a Goniophotometer (Gonio/Far Field Profiler) manufactured by Genesia Corporation so that a filter surface of the pop noise reduction tool was vertical with respect to outgoing light, and linear transmitting light was measured at 0° with respect to the outgoing light. In the measurement, first, a value was obtained by performing measurement without a sample, and then, a value measured in a state where a measurement sample was present was divided by the value (100%) where no sample was present to calculate the linear light transmittance (%). The result is shown in Table 2.

TABLE 1
(Pop noise reduction feature)

| | Frequency (Hz) | | | | | | |
|---|---|---|---|---|---|---|---|
| | 30 | 50 | 70 | 100 | 200 | 300 | |
| | Pop noise (dB) | | | | | | Sound |
| Without | 95 | 93 | 93 | 98 | 92 | 92 | transmission |
| reduction tool¹⁾ | Pop noise attenuation (dB) | | | | | | feature |
| Example 1 | 30 | 31 | 29 | 40 | 30 | 38 | Excellent |
| Example 2 | 32 | 33 | 32 | 45 | 33 | 40 | Excellent |
| Example 3 | 40 | 42 | 39 | 43 | 35 | 41 | Excellent |
| Example 4 | 43 | 43 | 42 | 45 | 38 | 44 | Excellent |
| Example 5 | 25 | 25 | 26 | 35 | 29 | 35 | Excellent |
| Example 6 | 27 | 25 | 25 | 37 | 28 | 28 | Excellent |
| Comparative | 20 | 20 | 20 | 33 | 33 | 37 | Poor |
| Example 1 | | | | | | | |
| Comparative | 4 | 2 | 7 | 22 | 27 | 26 | Excellent |
| Example 2 | | | | | | | |
| Comparative | 25 | 23 | 26 | 35 | 29 | 27 | Poor |
| Example 3 | | | | | | | |

Without reduction tool¹⁾ represents pop noise values at each frequency when there is no pop noise reduction tool, and pop noise attenuations in Example and Comparative Example represent pop noise attenuations in a state where there is no pop noise reduction tool.

TABLE 2
(Presence or absence of micropores and linear light transmittance)

| | Presence or absence of micropores | | |
|---|---|---|---|
| | Presence or absence | Maximum pore | Linear light |
| | of micropores | diameter (μm) | transmittance (%) |
| Example 1 | Present | 78 | 0.25 |
| Example 2 | Present | 83 | 0.00 |
| Example 3 | Present | 78 | 0.00 |
| Example 4 | Present | 83 | 0.00 |
| Example 5 | Present | 128 | 1.90 |
| Example 6 | Present | 220 | 13.60 |
| Comparative | Present | 250 | 42.02 |
| Example 1 | | | |
| Comparative | Present | 2000 | 75.43 |
| Example 2 | | | |
| Comparative | Present | — | 40.03 |
| Example 3 | | | |

As shown in Table 1 and Table 2, in Examples 1 to 6, the presence of micropores and the maximum pore diameter were confirmed by the bubble point method. In Comparative Examples 1, 2, and 3, through-hole micropores are at such levels as to be visually confirmed, and their maximum pore diameter values are values calculated through observation using a microscope.

Further, in the examples except for Comparative Examples 1 and 3, it can be understood that insertion loss is almost negligible and whole sound transmission is performed. In the case of Comparative Examples 1 and 3, there was insertion loss as a frequency of 2 dB or greater and 5 dB or less, and in this situation, the total sound transmission cannot be expected.

Furthermore, the linear light transmittances of the pop noise reduction tools in Examples 1 to 6 that employed the sound-transmitting members in which fibers were interlaced with each other were 20% or less, and the linear light transmittances of the pop noise reduction tools in Comparative Examples 1 to 3 that employed the sound-transmitting members having through-holes capable of being visually confirmed over the entire surface thereof exceeded 40%.

With respect to the pop noise reduction feature, in a frequency band of 30 Hz to 100 Hz, Examples 1 to 6 showed reduction effects of 25 dB to 45 dB. On the other hand, Comparative Example 2 had approximately the same insertion loss as in Examples 1 to 6, but showed only a reduction effect of 22 dB at most. Further, Comparative Examples 1 and 3 having poor insertion loss showed only a reduction effect of 35 dB at most.

Further, through confirmation of the pop noise reduction effect using the pop noise measurement method and the noise measurement device according to the embodiment of the invention, it was found that the pop noise reduction tool according to the embodiment of the invention could effectively reduce pop noise particularly at a low frequency compared with a related art technique.

### Example 7

A pop noise attenuation was measured in a similar way to Example 2, except that 3 mm which was the distance between the centers of the sound-transmitting members in Example 2 was changed to 1.5 mm. The result is shown in Table 3.

### Example 8

A pop noise attenuation was measured in a similar way to Example 1 except that a cross section of an edge portion of the sound-transmitting member used in Example 1 was rounded as shown in FIG. 6A. The result is shown in Table 3.

### Example 9

A pop noise attenuation was measured in a similar way to Example 1 except that a flange was provided in the end portion of the sound-transmitting member used in Example 1 so that its cross section was as shown in FIG. 6B. The result is shown in Table 3.

TABLE 3

Frequency (Hz)

| | | | | | |
|---|---|---|---|---|---|
| 30 | 50 | 70 | 100 | 200 | 300 |

Pop noise reduction (dB)

| | | | | | | |
|---|---|---|---|---|---|---|
| Example 7 | 30 | 30 | 30 | 39 | 29 | 38 |
| Example 8 | 35 | 36 | 33 | 45 | 36 | 40 |
| Example 9 | 36 | 35 | 32 | 44 | 37 | 39 |

As shown in Table 3, a pop noise attenuation in Example 7 in which two sound-transmitting members are used and a distance between the centers thereof is 1.5 mm is approximately the same as in Example 1 in which one sound-transmitting member is used.

Pop noise attenuations in Examples 8 and 9 are smaller than that in Example 3 where the sound-transmitting member is attached as a wind shield and Example 4 in which a vibration-proof material is provided between two sound-transmitting members. However, it is obvious that the pop noise attenuations in Examples 8 and 9 are superior to the pop noise attenuation in Example 1 in which the edge portion of the sound-transmitting member is flat without being rounded or flanged.

### REFERENCE SIGNS LIST

1 sound-transmitting member

2 noise measurement device

3 silent shock wind generator controller

4 DC-coupled sound card

5 DC power amplifier

6 silent shock wind generator

10 elastic member

20 frame

30 diaphragm

31 coil

32 head case

33 diaphragm fixture

61 high-compliance roll edge speaker

62 shock wind speed-up adaptor

101 wind shield

621 first speed-up adaptor

622 second speed-up adaptor

623 pipe

624 mechanical impedance-adjusting member

7 sound acquisition unit

8 speaker box

9 glass wool

10 vibration-proof material

a speaker

b sound-transmitting member or pop noise reduction tool

c microphone

z distance between centers of sound-transmitting members

1. A pop noise reduction tool comprising at least a sound-transmitting member which has micropores that lead from one surface thereof to the other surface thereof and is formed by fibers that are interlaced with each other, and has a linear light transmittance of 20% or less.

2. The pop noise reduction tool according to claim 1,
wherein the sound-transmitting member is mounted on a microphone, and further serves as a wind shield for protecting a microphone unit.

3. The pop noise reduction tool according to claim 1,
wherein the pop noise reduction tool comprises at least two sound-transmitting members.

4. The pop noise reduction tool according to claim 3,
wherein at least one of the sound-transmitting members has a thin plate shape, and another one thereof serves as a wind shield for protecting a microphone unit and is mounted on a microphone.

5. The pop noise reduction tool according to claim 3,
wherein the sound-transmitting members are arranged so that a distance therebetween is 2 mm to 50 mm.

6. The pop noise reduction tool according to claim 1,
wherein a linear distance between a diaphragm of a microphone unit and at least one of the pop noise reduction tools is equal to or greater than 25 mm.

7. The pop noise reduction tool according to claim 1,
wherein vibration-proofing of the sound-transmitting member is secured by an elastic member.

8. The pop noise reduction tool according to claim 1, wherein the pop noise reduction tool further comprises a fixing member for fixing the pop noise reduction tool at a predetermined position.

9. The pop noise reduction tool according to claim 1,
wherein a pop noise attenuation measured by a pop noise measurement method comprising a pop noise reproduction process of generating a silent shock wind and a sound acquisition process of acquiring pop noise generated by a shock wind generated in the silent shock wind generation process is equal to or greater than 25 db.

10. A pop noise measurement method comprising:
a pop noise reproduction process of generating a silent shock wind; and
a sound acquisition process of acquiring pop noise generated by a shock wind generated in the silent shock wind generation process.

11. The pop noise measurement method according to claim 10,
wherein in the sound acquisition process of acquiring pop noise, a plosive sound is divided into a sound part, and pop noise generated by a shock wind, and only the pop noise is acquired.

12. A pop noise measurement device comprising:
a pop noise reproduction unit that includes at least a device that drives means for generating a silent shock wind and a silent shock wind generator that generates a silent shock wind; and
a sound acquisition unit that acquires pop noise generated by a shock wind generated by the silent shock wind generator.

13. The pop noise measurement device according to claim 12,
wherein the sound acquisition unit divides a plosive sound into a sound part and pop noise generated by a shock wind, and acquires only the pop noise.

14. The pop noise measurement device according to claim 13,
wherein the silent shock wind generator includes a speaker, at least one speed-amplifying adaptor that increases the speed of a silent shock wind generated from the speaker, a rectifier that rectifies the silent shock wind, and an impedance adjuster that prevents the occurrence of an abnormal sound.

15. A microphone comprising the pop noise reduction tool according to claim 1.

16. The microphone according to claim 15,
wherein the pop noise reduction tool is provided to cover the inside of a head case.

17. The microphone according to claim 15,
wherein the pop noise reduction tool is provided to cover a diaphragm without being in contact with the diaphragm.

18. The microphone according to claim 15,
wherein a pop noise reduction tool is provided to cover the inside of a head case, and another pop noise reduction tool is provided to cover a diaphragm without being in contact with the diaphragm.
